(19) United States
(12) Patent Application Publication
(10) Pub. No.: US 2015/0317968 A1
(43) Pub. Date: Nov. 5, 2015

(54) SOUND CONTROL DEVICE, SOUND CONTROL METHOD AND PROGRAM

(71) Applicant: Mayumi Yamada, Hamamatsu-shi, Shizuoka (JP)

(72) Inventor: Mayumi Yamada, Hamamatsu-shi, Shizuoka (JP)

(21) Appl. No.: 14/440,350

(22) PCT Filed: Aug. 31, 2012
(86) PCT No.: PCT/JP2012/005513

§ 371 Date: Jul. 15, 2015

(30) Foreign Application Priority Data
Jul. 31, 2012 (JP) 2012-170515

(51) Int. Cl. G10H 7/00; H04R 1/00

(52) U.S. Cl. CPC G10H 7/008; H04R 1/00

(57) ABSTRACT

A sound control device capable of allowing a user to perceive sound by physical tension and relaxation is provided. The sound control device may include an interface portion 15 for receiving a load input indicating a load size perceived by a user due to user operation; and a control portion 50 for outputting a sound to a speaker 40 corresponding to the load input received by the interface portion 15. The control portion 50 may output a dominant tone sound to the speaker 40 in a first state where the size of the load indicated by the load input is larger than a predefined size. The control portion 50 may output a tonic tone sound to the speaker 40 in a second state where the size of the load indicated by the load input has decreased to less than the predefined size of the first state.

### CROSS REFERENCE TO RELATED APPLICATIONS

The present application claims the benefit of and priority to Japanese patent application number JP2012-170515, filed Jul. 31, 2012, and to PCT patent application number PCT/JP2012/005513, filed Aug. 31, 2012.

### TECHNICAL FIELD

The present invention relates to a sound control device.

### BACKGROUND

Technology not only directed to the simple listening of music, but also for experiencing music as physical sensations, is conventionally known. JP 3,341,238 discloses a device capable of allowing music to be experienced as physical sensations through vibrations to the human body.

An object of the present invention is to provide a sound control device capable of allowing a user to perceive music (sound) by physical tension and relaxation.

A sound control device according to one embodiment of the present invention is characterized by including: an interface portion for receiving a load input indicating a load size perceived by a user due to user operation; and a control portion for outputting a sound to a speaker corresponding to the load input received by the interface portion; wherein the control portion outputs a dominant tone sound to the speaker in a first state where the size of the load indicated by the load input is larger than a predefined size; and wherein the control portion outputs a tonic tone sound to the speaker in a second state where the size of the load indicated by the load input has decreased to less than the predefined size of the first state.

Note that general and specific aspects of a sound control device may be implemented by systems, methods, integrated circuits, computer programs, and by computer readable recording media such as CD-ROMs, and by combinations of systems, methods, integrated circuits, computer programs, and recording media.

In accordance with the sound control device of the present invention, a user can perceive sounds by physical tension and relaxation.

### BRIEF DESCRIPTION ON THE DRAWINGS

FIG. 1 is a diagram for explaining spring-like qualities of music.

FIG. 2 is a block diagram indicating a sound control device system configuration according to the first embodiment.

FIG. 3 is an external view of the first embodiment of the sound control device.

FIG. 4 is a diagram for explaining operation of the sound control device.

FIG. 5 is a flowchart indicating operation of the sound control device.

FIG. 6 is a diagram for explaining a plurality of thresholds set with respect to user load input.

FIG. 7 is a diagram for explaining the results of an experiment performed to corroborate an effect of a sound control device.

FIG. 8 is a diagram for explaining the results of an experiment performed to corroborate an effect of a sound control device.

FIG. 9 is an external view of a second embodiment of a sound control device.

FIG. 10 is a diagram showing an example application of a sound control device.

FIG. 11 is a diagram showing an example of applying a sound control device to a tablet-type terminal device.

FIG. 12 is a diagram for explaining operation when applying a sound control device to a tablet-type terminal device.

FIG. 13 is a block diagram indicating a sound control device system configuration according to the second embodiment.

FIG. 14 is a diagram for explaining operation of a sound control device according to the second embodiment.

FIG. 15 is a diagram showing a case where a sound control device is applied to an entry gate.

FIG. 16 is a diagram showing a case where a sound control device is applied to an automatic turnstile.

### DETAILED DESCRIPTION OF THE EMBODIMENTS

The present invention relates to a sound control device by which a user is able to physically experience the spring-like qualities of music by perceiving feelings of tension and subsequent relaxation in a sound as physical tension and relaxation in the user's body.

Note that the term sound control as used herein is not limited to a user simply controlling a sound. Further, as used herein the term sound control does not simply mean changing a sound based upon an operation. For example, if the user continues to apply a force to an interface portion, sound tinged with the spring-like qualities of music may be output based on returning the user to a natural state from a tired state.

The spring-like qualities of music as used herein are explained first.

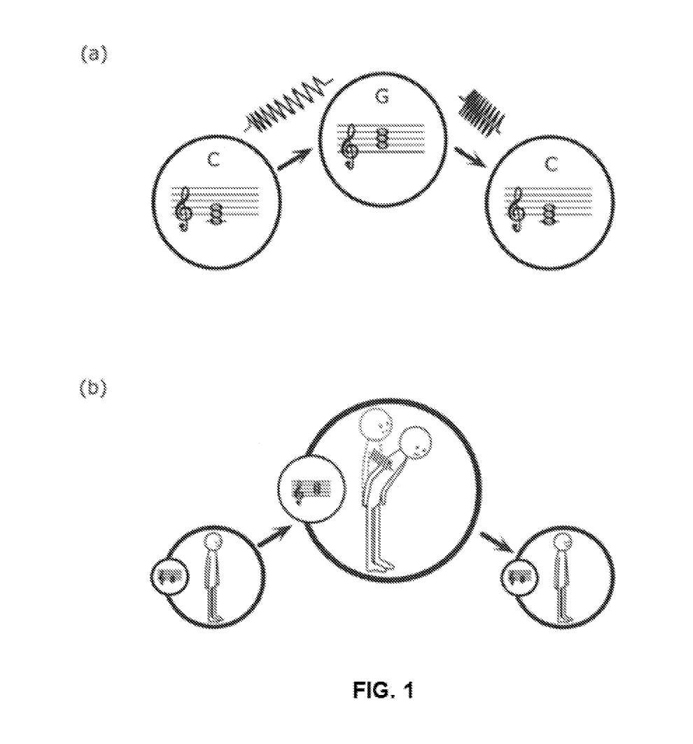

FIG. 1 is a diagram for explaining spring-like qualities of music. FIG. 1a is a diagram indicating a relationship between a tonic chord and a dominant chord.

The term tonic chord indicates a chord whose fundamental tone is a tonic sound. A tonic sound in FIG. 1 is the note C, and the tonic chord is a C chord. Further, in the following explanation a C chord is not limited to the notes C-E-G, but also includes morphologically transformed chords such as E-G-C and G-C-E. Chords other than the C chord are also treated similarly.

The term dominant chord indicates a chord whose fundamental tone is a dominant sound. The tonic sound in FIG. 1 is a C note, and therefore the dominant sound is a sound one fifth over C, which is a G note. The dominant chord is thus G-B-D.

If a person listens to a dominant chord after a tonic chord, the person may possess a quality of wanting to again listen to a tonic chord. In this embodiment, this sound quality is referred to as the spring-like qualities of music, similar to the extension and contraction of a spring, for example.

The spring-like qualities of music may be utilized as shown in FIG. 1b, a scene often found in music classes in Japanese schools, where an individual bows in time with the sound of a piano.

As FIG. 1b shows, after playing the tonic chord C, the dominant chord G is played, and students take this as an opportunity to bow from an upright standing. The students' bodies can be thought to be in a tense state at this point.

Next, the students return to an upright standing position when the tonic chord C is once again played. It can be said that, for the students, this is a state where both body and mind are relaxed.

Figure skating may be given as another example of the spring-like qualities of music. In figure skating, suitable choreography is selected to match a song. For example, when a dominant chord from a composition is played, a performer may be in a low body position, tensed before a jump. The actual jump may then take place when a tonic sound is played next. By synchronizing the music and choreography, the skater is able to perform a very high jump with good feeling, reducing the number of mistakes during the performance. The choice of music is known to be extremely important for figure skaters.

The present invention provides a sound control device that closely associates the tension states and relaxed states arising due to the spring-like qualities of music with physical tense states and relaxed states, thus allowing a user to clearly and physically experience the spring-like qualities of music by experiencing sound as tension and relaxation.

Specifically, in one embodiment of the present invention, a sound control device may include: an interface portion for receiving a load input indicating a load size perceived by a user due to user operation; and a control portion for outputting a sound to a speaker corresponding to the load input received by the interface portion. The control portion may output a dominant tone sound to the speaker in a first state where the size of the load indicated by the load input is larger than a predefined size; and may output a tonic tone sound to the speaker in a second state where the size of the load indicated by the load input has decreased to less than the predefined size of the first state.

Further, in one embodiment of the present invention, the control portion may output a dominant chord sound, a sub-dominant chord sound, or a sub-dominant minor chord sound to the speaker as the dominant tone sound in the first state; and may output a tonic chord sound to the speaker as the tonic tone sound in the second state.

Further, in one embodiment of the present invention, the control portion may output a first song to the speaker as the dominant tone sound in the first state; and may output a second song to the speaker as the tonic tone sound in the second state, the second song imparting less of a sense of tension to the user than the first song.

Further, in one embodiment of the present invention, the control portion may output a leading note to the speaker as the dominant tone in the first state; and may output a tonic to the speaker as the tonic tone to the speaker in the second state.

Further, in one embodiment of the present invention, the control portion may output a predefined song to the speaker; and may output a bar portion of a dominant chord, or a sub-dominant chord, of the predefined song to the speaker as the dominant tone sound in the first state; and may output a bar portion of a tonic chord of the predefined song to the speaker as the tonic tone sound in the second state.

Further, in one embodiment of the present invention, the control portion may output a first tempo dominant tone sound to the speaker in the first state; and may output a second tempo tonic tone sound to the speaker in the second state, the second tempo being less than the first tempo.

Further, in one embodiment of the present invention, the control portion may output a first tempo dominant tone sound to the speaker in the first state; and may output a second tempo tonic tone sound to the speaker in the second state, the second tempo being slower than the first tempo.

Further, in one embodiment of the present invention, from a state where the control portion outputs a tonic tone sound to the speaker, the control portion may then output a dominant tone sound to the speaker in the first state when the size of the load indicated by the load input becomes larger than a predefined size.

Further, in one embodiment of the present invention, the interface portion may include: an elastic member that extends and contracts according to the user operation; and a detection portion that detects an elastic force on the elastic member due to the user operation as the load input. The first state may be a state where the elastic force on the elastic member detected by the detection portion due to the user operation is equal to or greater than a first threshold value; and the second state may be a state where the elastic force on the elastic member detected by the detection portion due to the user operation is less than a second threshold value.

Further, in one embodiment of the present invention, the interface portion may include: a display screen; and a touch panel overlaying the display screen for receiving the load input of the user due to a touch action of the user. The control portion may display a virtual elastic member on the display, and the virtual elastic member allowing the user to recognize a load due to expansion and contraction caused by the touch operation of the user. The first state may be a state where the size of the load displayed according to an expansion or contraction amount of the virtual expansion member is equal to or greater than a predefined size; and the second state may be a state where the size of the load displayed according to the amount of expansion or contraction of the virtual elastic member is less than the predefined size.

Further, in one embodiment of the present invention, a sound control device may include: an interface portion for receiving a load input indicating a load size perceived by a user due to user operation; and a control portion for outputting a sound to a speaker corresponding to the load input received by the interface portion. The control portion may output a first sound to the speaker in a first state where the size of the load indicated by the load input is larger than a predefined size; and may output a second sound to the speaker in a second state where the size of the load indicated by the load input has decreased to less than the predefined size of the first state. The second sound may impart less of a sense of tension to the user than the first sound.

Further, in one embodiment of the present invention, a sound control device may include: an interface portion for receiving a load input indicating a load size perceived by a user due to user operation; and a control portion for outputting a sound to a speaker corresponding to the load input received by the interface portion. The control portion may output a first sound to the speaker in a first state where the size of the load indicated by the load input is larger than a predefined size; and wherein may output a second sound to the speaker in a second state where the size of the load indicated by the load input has decreased to less than the predefined size of the first state. The second sound may cause the user to relax more than the first sound.

Further, in one embodiment of the present invention, a method of controlling sound to output a sound to a speaker using an interface portion for receiving a load input, recognized by a user, according to an operation by the user, may include: outputting a dominant tone sound to the speaker in a first state where the size of the load displayed according to the load input is greater than a predefined size; and outputting a tonic tone sound to the speaker in a second state where the size of the load displayed according to the load input is less than the predefined size from the first state.

Embodiments of the present invention are explained below with reference to the figures. Note that the embodiments explained below are all specific examples of preferred embodiments of the present invention. Numerical values, shapes, structural elements, layout positions and connectivity, process steps, step order, and the like are all merely exemplary and the present invention is not limited to those examples. Further, among the constitutive elements in the embodiments described below, those constitutive elements not described in independent claims showing the highest level concepts are explained as arbitrary constitutive elements.

### Embodiment 1

Embodiment 1 of the present invention is explained below.

Configuration

First, a configuration of a sound control device according to embodiment 1 is explained below.

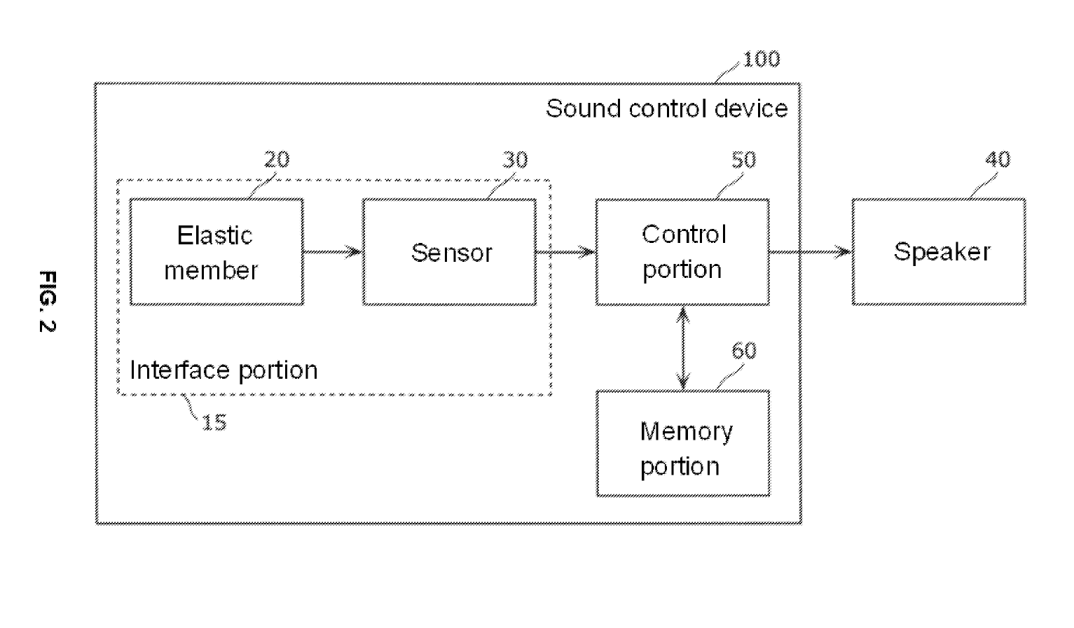

FIG. 2 is a block diagram indicating a sound control device system configuration according to a first embodiment.

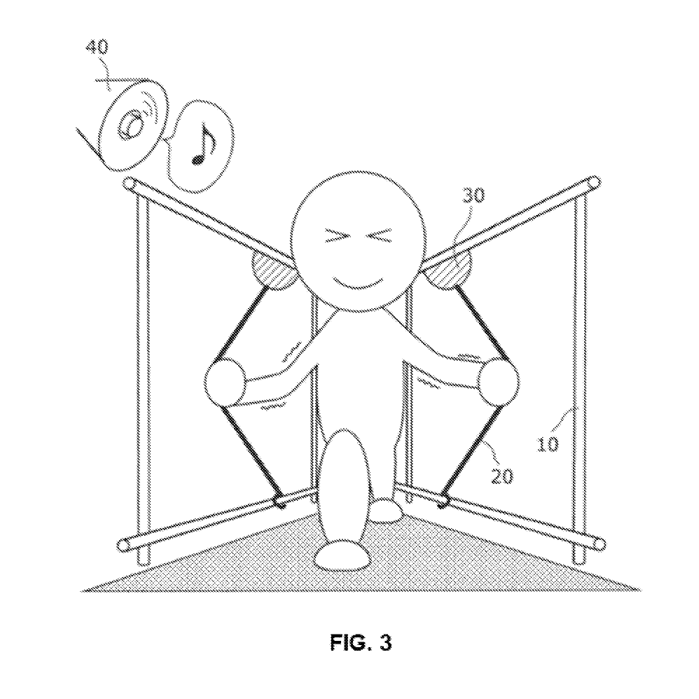

FIG. 3 is an external view of the first embodiment of a sound control device.

As shown in FIG. 2, a sound control device 100 includes an interface portion 15, a control portion 50, and a memory portion 60. The sound control device 100 is connected to a speaker 40 by using a wire or wirelessly.

The interface portion 15 includes an elastic member 20 and a sensor 30 (sensor portion).

The elastic member 20 is a rubber member that extends and contracts in response to user operations. The elastic member is not limited to rubber, and a spring, silicon, polymer, or other substance that is able to extend and contract may also be used.

As FIG. 3 shows, one end of the elastic member 20 is connected to a support member 10, and another end of the elastic member 20 may be connected to the sensor 30, which is provided on the support member 10. Note that the sound control device 100 according to the present embodiment as shown in FIG. 3 includes two elastic members 20; one elastic member allows a user to input a load using a right hand, and another elastic member 20 allows the user to input a load using a left hand.

The sensor 30 detects an elastic force, which is user load input, on the elastic member 20, and outputs detection results to the control portion 50. The sensor 30 is an electrostatic capacitance three-axis force sensor capable of detecting elastic force on the elastic member 20 whether the elastic force acts on the elastic member 20 in a contraction or extension direction. Note that the sound control device 100 shown in FIG. 3 is provided with two sensors, one sensor 30 for detecting an input load that is input by right hand operations of a user, and one sensor 30 for detecting an input load that is input by left hand operations of the user.

The control portion 50 outputs a sound to the speaker 40 in response to user load input, which corresponds to output from the sensors 30. The control portion 50 can be made by using semiconductor elements or the like. The control portion 50 may be configured using only hardware, and may also be configured using a combination of hardware and software. Further, the control portion can be configured using a microcomputer.

The memory portion 60 is a recording medium such as a semiconductor memory or a hard disk drive (HDD). Information is stored in the memory portion 60 on a plurality of sound sources (dominant tone sounds and tonic tone sounds) that the control portion 50 outputs to the speaker 40 in response to output from the sensors 30. The sound sources stored in the memory portion 60 may be created in consideration of the spring-like qualities of music, and/or may be existing sound sources selected in consideration of the spring-like qualities of music.

Spring-Like Qualities of Music

Spring-like qualities of music are explained here in detail. Five qualities are provided here as typical examples of the spring-like qualities of music.

1. Chord Spring (Relationship Between Chords)

As discussed above, in the delivery of music, for example, when moving from a tonic chord to a dominant chord (or to a subdominant chord), it is normal to return to the tonic chord from the dominant chord. That is, when delivering music, a state where there has been movement from a tonic chord to a dominant chord can be thought of as a spring transitioning from a normal state to an extended or compressed state (tensed state). A state when there is a return to a tonic chord can be compared to returning the spring from an extended or compressed state to a normal state (relaxed state).

2. Leading Note Spring (Relationship Between Single Notes)

In a case where a melody constructed of the single notes “C-D-E-F-G-A-B-C” is performed, for example, a listener may expect to hear the note “C” after the notes “C-D-E-F-G-A-B” are performed. That is, a state where “C-D-E-F-G-A-B” have been played can be compared to a spring having been extended or compressed from its normal state. A state achieved after the note “C” is performed can be compared to a state where the spring returns to its normal state from an extended or compressed state. Note that, in this case, no matter what note precedes “B” (for example, instead of “A” preceding “B”, a case where “G-C” precedes “B”), there is a tendency for a listener to want to hear a “C” note next.

3. Song Playing Spring (Relationship During Song Progression)

When playing a song from a certain phrase, there are many cases where the song is constructed to finally return to an initial phrase. For example, when a song is played having phrase A, phrase B, phrase C, and phrase A in order, a state where the song has been played up through phrase C can be compared to a state where a spring has been extended or compressed from its normal state. A state where phrase A is subsequently played can be compared to a state where the spring has returned to normal from an extended or compressed state.

Further, there is a typical chord progression in songs. A song may be constructed to begin from a phrase having a chord that is the key in which the song is written. After a progression of subdominant, subdominant minor, or dominant chord phrases, the song may return to a tonic chord phrase at the end. In this case the dominant chord phrase can be compared to a state where a spring has been extended or compressed from its normal state. A tonic chord phrase can be compared to a state where a spring is in its normal, non-extended or compressed state.

4. Rhythm Spring (Relationship Between Rhythms)

In a state where a snare drum is continually played for a short period of time, such as during a drum roll, for example, a person may likely feel relief from a tensed state when the continuous play stops. This can be seen during school field days and the like when playing a snare drum and then stopping in conjunction with a command to stop all movement. That is, a state where a snare drum is played continuously for a short period of time during a song can be compared to a state where a spring is extended or compressed, and the point where the continuous play of the snare drum is stopped in a song can be compared to a state where a spring has returned to its normal state from a state where it is extended or compressed. Further, for one song, a portion having a high tempo rhythm can be compared to a spring being extended or compressed from its normal state, while a portion having a slow tempo rhythm can be compared to a state where a spring is not extended or compressed.

5. Timbre or Sound Pressure Spring (Relationship Between Timbres or Sound Pressures)

With an orchestra sound source, for example, various instruments are played simultaneously. That is, an orchestral sound source is one in which the timbres of each instrument are superposed. It is thus possible to obtain spring-like qualities of music by increasing or decreasing the number of sound timbres in a sound created by superimposing a plurality of sound timbers. In other words, sound having many timbres (where the number of superimposing sounds is high) can be compared to a spring in an extended or compressed state, while sound having few timbres (where the number of superimposing sounds is low), can be compared to a spring in a normal state not extended or compressed.

Note that timbre is determined according to frequencies making up a sound, and the strength distribution in those frequencies. Therefore a sound having an expanding timbre or a sound having a comprehensive timbre may be created by performing acoustic signal processing on the frequencies of a sound, determining phase differentials in superimposed sounds, and the like. In this case an expanding timbre sound can be compared to a spring in an extended or compressed state, while a comprehensive timbre sound may be compared to a spring in a normal state, not extended or compressed.

Further, when a person moves from a noisy location to a quiet location, the person may receive an impression of having been set free from a tensed state. That is, sound having a large sound pressure (a loud sound) can be compared to a spring in an extended or compressed state, while sound having a small sound pressure (a quiet sound) can be compared to a spring in a normal state, not extended or compressed.

Typical examples of the spring-like qualities of music have been explained above. In this embodiment, dominant tone sounds and tonic tone sounds stored in the memory portion 60 may be sound sources selected, composed, or combinations of sound sources selected and composed, in consideration of the five spring-like qualities of music described above. The term dominant tone sound means a sound that can be compared to a tense state in the spring-like qualities described above. The term tonic tone sound, on the other hand, means a sound that can be compared to a relaxed state in the spring-like qualities described above.

Note that tonic tone sounds and dominant tone sounds may be respective sounds corresponding to relative tense states and relaxed states. That is, when making a relative comparison of a tonic tone sound to a dominant tone sound, the dominant tone sound is one that imparts more of a tense state to a listener than a tonic tone sound. A tonic tone sound is a sound that imparts more of a relaxed state to a listener than a dominant tone sound.

The present invention can be implemented as an interface that imparts physical tension and relaxation to a user through a natural sensation of body movement depending upon a sensation where a dominant tone sound is resolved by a tonic tone sound.

Operation

Operation of the sound control device 100 is explained next.

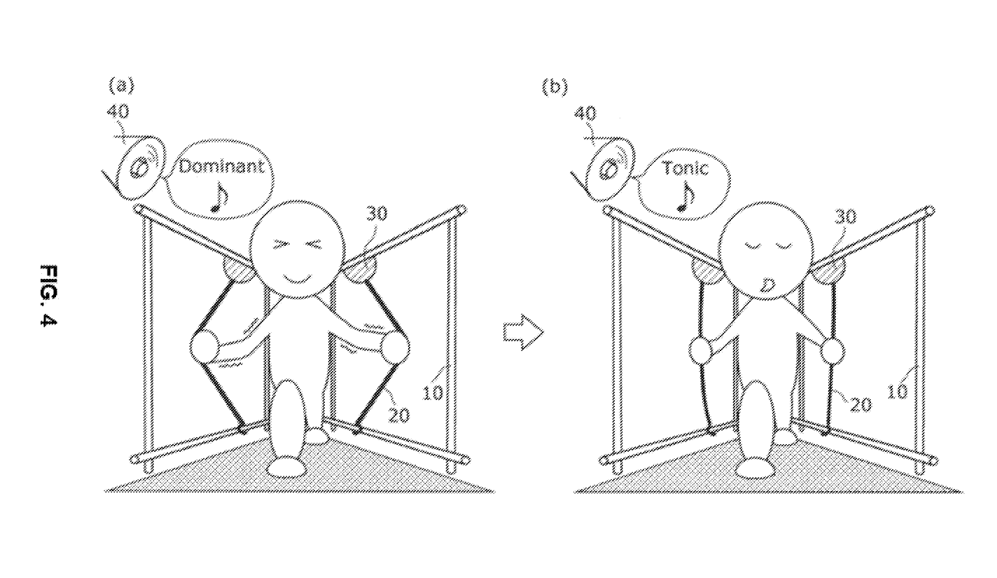

FIG. 4 is a diagram for explaining the operation of the sound controller 100.

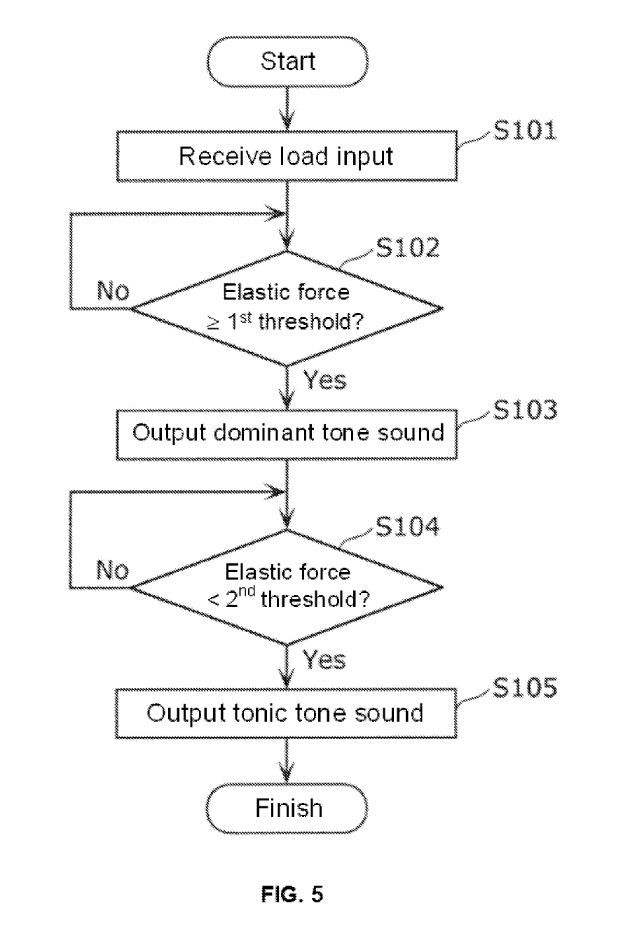

FIG. 5 is a flowchart indicating operation of a sound control device.

First, the interface portion 15 receives load input from a user at S101 in FIG. 5. Specifically, the sensor 30 detects elastic force on the elastic member 20, which is a load input by the user against a restorative force of the elastic member 20. FIG. 4a indicates a state where the user inputs a load on the elastic member 20, and the elastic member 20 is in an extended state.

Next, the control portion 50 determines whether or not the elastic force detected by the sensor 30 is equal to or greater than a first threshold at S102 in FIG. 5. In other words, the control portion 50 determines whether or not the size of the load perceived by the user when operating the elastic member 20 (substantially equal to the elastic force detected by the sensor 30) is in a first state larger than a predefined value. When the elastic force of the elastic member 20 is in the a state equal to or greater than the first threshold, that is when the elastic force is in the first state (Yes at S102 in FIG. 5), the control portion 50 outputs a dominant tone sound at S103 in FIG. 5.

FIG. 4a is a diagram showing the first state. As shown in FIG. 4a, in the first state the load due to elastic force on the elastic member 20 is imparted to the user's body, and therefore the users body can be said to be in a state of tension. Further, in the first state a dominant tone sound, which is a tense feeling sound, is output from the speaker 40.

In a state where the control portion 50 outputs a dominant tone sound to the speaker, the control portion 50 determines whether or not the elastic force output by the sensor 30 is less than a second threshold at S104 in FIG. 5. In other words, the control portion 50 determines whether or not the size of the load perceived by the user operating the elastic member 20 (substantially equal to the elastic force detected by the sensor 30) is in a second state less than a predefined size.

For a state where the load imparted by the user to the elastic member is reduced in accordance with the restorative force of the elastic member 20, the elastic force detected by the sensor 30 is in a state equal to or less than the second threshold, in other words when the load imparted by the user is in the second state (Yes at S104 in FIG. 5), the control portion 50 outputs a tonic tone sound to the speaker at S105 in FIG. 5. Note that the first threshold value and the second threshold value may be set to identical values, and that they may also be set to different values.

FIG. 4b is a diagram showing the second state. As shown in FIG. 4b, in the second state the user's body is in a relaxed state released from the load due to the elastic force on the elastic member 20. Further, in the second state a tonic tone sound is output from the speaker 40. Namely, a sound having a stable feeling, where the feeling of tension is relaxed, is output from the speaker 40.

As described above, according to the sound control device 100, a physical sensation by a user of pulling on an elastic member and then releasing is coupled to a tense feeling of music that is then released, and the user can thus physically experience the spring-like qualities of music.

Note that the control portion 50 may output a tonic tone sound to the speaker 40 in the step S101 and the step S102 of FIG. 5. The tonic tone sound may be identical to the tonic tone sound output from the speaker 40 in the step S105, and may also be a different sound.

Examples of dominant tone sounds and tonic tone sounds are explained next.

First, an example of a case where a melody composed of the single notes “C-D-E-F-G-A-B-C” is used as a sound source played by a musical instrument, in other words a leading note spring, is explained. In a normal state (at S101 and S102 in FIG. 5), the control portion repeatedly outputs the melody “C-D-E-F-G-A-B-C” played by a musical instrument. Note that it is not always necessary to repeatedly output “C-D-E-F-G-A-B-C” here.

In the first state, at S103 in FIG. 5, the control portion 50 outputs “C-D-E-F-G-A-B” as the dominant tone sound, continuing to stretch the “B” note played by musical instrument. Note that, as explained regarding a leading note spring, when “B” is output, “C-D-E-F-G-A” does not have to be output.

In the second state, at S105 in FIG. 5, the control portion 50 outputs “C” to the speaker 40 as a tonic tone sound. In this cases “C” is a “C” up a semitone above the continuously output “B”. However, a “C” one octave lower than the “B” may also be used.

Next, an example of a song composed of a phrase A, a phrase B, a phrase C, and then the phrase A, in order, is explained as a separate example. In other words, a song playing spring is explained. In a normal state (at S101 and S102 in FIG. 5), the control portion 50 repeatedly outputs the song including the phrases A, B, C, and A, in that order, to the speaker 40 as a tonic tone sound.

In the first state, at S103 in FIG. 5, the control portion 50 repeatedly outputs the phrase C only has the dominant tone sound. In this case, output of the phrase C may begin immediately after the control portion 50 determines that the sound control device is in the first state. Alternatively, repeated output of the phrase C may begin from the first regular phrase C output that occurs after the control portion 50 determines that the sound control device is in the first state.

Further, the control portion 50 may continuously output the final note of the phrase C instead of repeatedly outputting the entire phrase C. Specifically, the final note of the phrase C may be continuously output (may be elongated) from the first instance of phrase C output after the control portion 50 determines that the sound control device is in the first state.

In the second state, at S105 in FIG. 5, the control portion 50 repeatedly outputs the phrases A, B, C, and A in order, as usual, as a tonic tone sound. In this case output of the phrase A may begin once the control portion 50 determines that the sound control device is in the second state. Alternatively, output of the phrase A may begin once output of the first phrase C is complete after the control portion determines that the sound control device is in the second state.

Note that in the normal state (at S101 and S102 in FIG. 5), the control portion 50 does not have to output any sound to the speaker 40. For example, if the song composed of the phrases A, B, C, and A is famous, and the user is very familiar with the song, the user will know that the phrase A is normally output after the phrase C, even if sound output begins from the first state. That is, it is also possible for the user to feel the spring-like qualities of music in this type of case.

Examples of dominant tone sounds and tonic tone sounds have been provided above. The dominant tone sounds and the tonic tone sounds used in this embodiment are not limited to those described above. The sounds may be selected, or composed, based on spring-like qualities of music like those described above. Combinations of such sounds may also be used.

Note that although a case where the first threshold value and the second threshold value are used in FIG. 4 and FIG. 5, three or more thresholds may also be used with respect to user inputs. That is, the control portion 50 may be configured to output two or more sounds to the speaker 40.

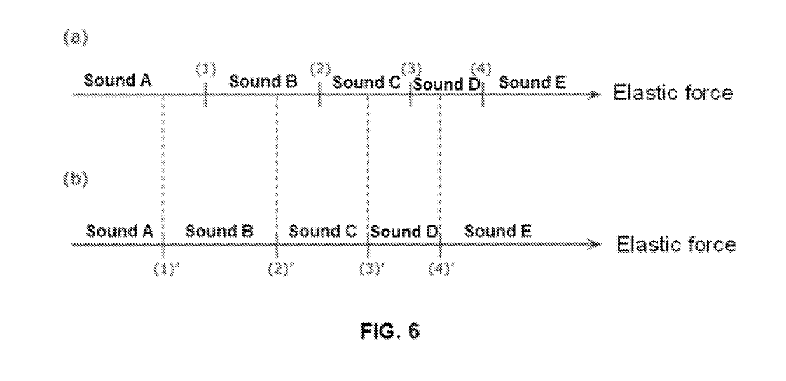

FIG. 6 is a diagram for explaining a plurality of thresholds set with respect to user load input. FIG. 6a is a diagram indicating a threshold 1 through a threshold 4 for elastic force imparted by a user load. FIG. 6b, on the other hand, is a diagram indicating a threshold 1′ through a threshold 4′ for elastic force when an imparted user load is reduced.

In FIG. 6, sound A through sound E are stored in the memory portion 60, and the control portion 50 outputs the sounds A through E to the speaker 40. The control portion 50 outputs the sound A through the sound E to the speaker 40 after comparing the elastic force detected by the sensor to the thresholds 1 through 5 (or to the thresholds 1′ through 5′).

The sound A is a sound having the strongest tonic tone, and the sound E is a sound having the strongest dominant tone. In FIG. 6, the sound A, the sound B, the sound C, the sound D, and the sound E, in order, have progressively stronger dominant tones. The sounds A through E may be created by, for example, changing the tempo of the song used in the rhythm spring described above in a step-wise manner, or by changing the sound pressure of the song used in a sound pressure spring in a step-wise manner.

Further, when using a chord spring, by adding a sound having a major seventh higher order of the fundamental note of a dominant chord, or by adding a sound having a major ninth higher order of the fundamental note of a dominant chord, or by adding a sound having both a major seventh higher order and a major ninth higher order of a dominant chord to a tonic tone, the strength of the tonic tone (feeling of tension) of a tonic chord can be changed. The tension feeling of this tonic tone sound is strengthened by the strength of the dominant tone played immediately prior to the tonic tone. Further, as shown in FIG. 6, the elastic force threshold values may be set differently for cases where the user increases the load applied (when the elastic force of the elastic member 20 becomes larger) and for cases where the user decreases the load applied (when the elastic force of the elastic member becomes smaller).

For example, consider when the user increases the load applied to the interface portion 15 (the elastic member 20). For cases where the elastic force on the elastic member 20 detected by the sensor 30 is equal or greater than the threshold 1, and less than the threshold 2, the control portion 50 outputs the sound B to the speaker 40. Similarly, for cases where the elastic force on the elastic member 20 detected by the sensor 30 is equal to or greater than the threshold 2 and less than the threshold 3, the control portion 50 outputs the sound C to the speaker 40.

On the other hand, consider when the user decreases the load applied to the elastic member 20. For cases where the elastic force on the elastic member 20 detected by the sensor 30 is equal to or greater than the threshold 1′, but less than the threshold 2′, the control portion 50 outputs the sound B to the speaker 40. The threshold 1′ is set less than the threshold 1 here, and the threshold 2′ is set less than the threshold 2. Similarly, when the load applied by the user to the elastic member 20 is decreased, and the elastic force on the elastic member 20 detected by the sensor 30 is equal to or greater than the threshold 2′ but less than the threshold 3′, the control portion 50 outputs the sound C to the speaker 40.

By thus setting threshold values differently for cases where the user increases the load applied to the elastic member 20, and where the user decreases the load applied to the elastic member, stable sounds can be output with respect to load inputs even in the vicinity of the thresholds.

In the example of FIG. 6, the cap between thresholds is set smaller as the elastic force increases. This is intended as a way to regulate the balance between the load felt by the user and the switching timing of output sounds. The user can thus physically, and very effectively, experience the spring-like qualities of music.

Note that the gaps between thresholds may also be set to differ when the user increases the force on the elastic member 20, and when the user decreases the force on the elastic member. Further, the sounds output by the control portion 50 to the speaker 40 may also be changed between when the user increases the force on the elastic member 20 and the user decreases the force on the elastic member 20.

Effects

As explained above, in the first state where a user increases the load applied to the interface portion 15, that is when the user feels physical load (tension), the control portion 50 outputs a dominant tone sound to the speaker 40 that allows the user to feel tension.

Further, in the second state where the user decreases the load applied to the interface portion 15, that is, in a state where the user feels less physical load than in the first state, the control portion 50 outputs a tonic tone sound to the speaker 40 that relaxes the feeling of tension.

The user can thus physically experience the spring-like qualities of music by perceiving sound as physical tension and relaxation.

Note that the physical experience of the spring-like qualities of music as used above means synchronizing the load (tension and relaxation) physically felt by the user with the tension and relaxation due to listening to sound.

The user can thus achieve a special relaxing effect both mentally and physically. Specifically, effects such as increasing the user's concentration ability, for example, and relieving user stress have been confirmed experimentally. Experimental results supporting these special effects are explained below.

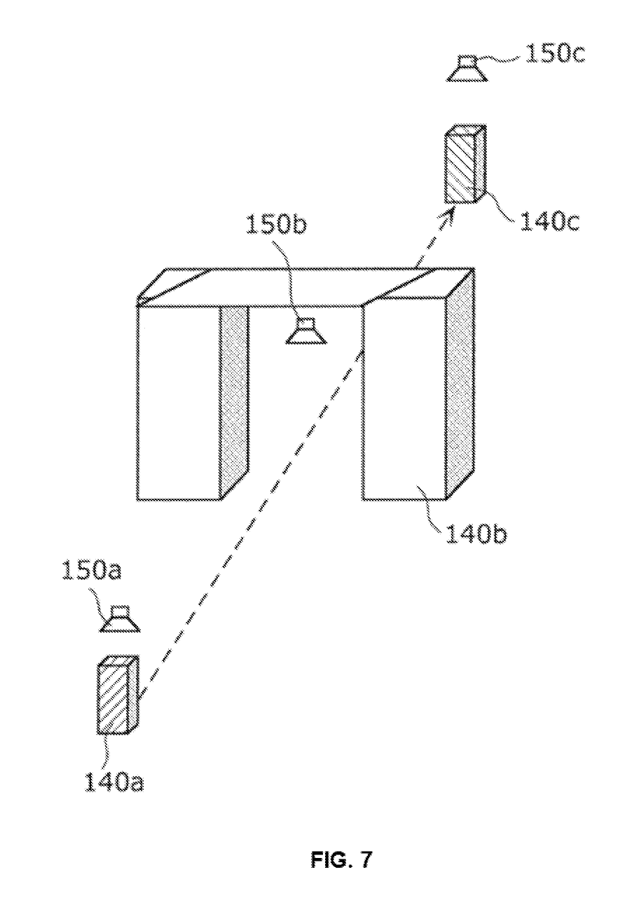

FIG. 7 is a diagram for explaining the content of an experiment performed to corroborate an effect of a sound control device.

As shown in FIG. 7, in this experiment, a position separated by 3 meters from a starting point 140a is taken as an end point 140c, and the exact intermediate point between the points 140a and 140c is taken as a tunnel 140b. An experiment was performed where a subject moves from the starting point 140a to the end point 140c without touching the tunnel 140b.

Speakers 150a, 150b, and 150c are arranged at the starting point 140a, the tunnel 140b, and the end point 140c, respectively. When moving, three environmental sound patterns are output from the speakers as shown by Table 1 below.

Note that in order to avoid mixing of the sounds output by each of the speakers, speakers with high sound directionality were used for the speakers 150a, 150b, and 150c.

TABLE 1

| | Speaker 150a | Speaker 150b | Speaker 150c |
|---|---|---|---|
| Pattern A | Tonic tone | Dominant tone | Tonic tone |
| | sound | sound | sound |
| Pattern B | Tonic tone | Tonic tone sound | Tonic tone |
| | sound | | sound |
| Pattern C | No sound | No sound | No sound |

In the experiment, chords played by piano were used as tonic tone sounds and dominant tone sounds. Identical speakers were used for the speakers 150, 150b, and 150c. The speakers were set up to be within 50 cm from the ear of the subjects, and the volume of sound output from the speakers was set at a base of 70 dB.

Subjects were tested under the sound environments shown in Table 1. The subjects started at the starting point 140a, went through the tunnel 140b, and passed through the end point 140c. Subjects were instructed to not touch the tunnel 140b when passing through.

The following two sets of data were acquired when testing four subjects under each of the environmental sound patterns.

First, data on the time required for subjects to move from the starting point to the end point was acquired. An average was taken for results of 30 separate resultant times per subject.

Second, the number of mistakes where a subject touched the tunnel while moving through the tunnel was taken. The total number of touches for 30 separate passes through the tunnel was found.

When performing the experiment, subjects wore weighted vests while moving, thus experiencing a load on their bodies greater than that normally felt. Note that male and female subjects were tested, each between 160 and 170 cm in height, and between 20 and 30 years of age.

Results obtained by the experiment are as discussed below.

First, a significant difference in the amount of time required to move from the starting point to the end point was not found for different environment sound patterns.

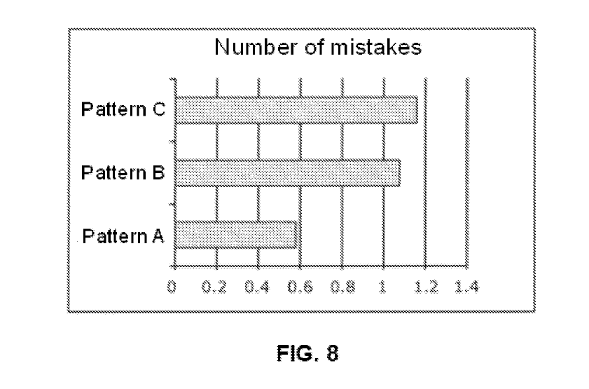

Next, as shown in FIG. 8, the number of mistakes was found to be significantly less for the sound pattern A compared to the sound patterns B and C.

With pattern A, a dominant tone sound having a high tension feeling was output when the subjects were passing through the tunnel 140b, where the subjects experienced the greatest physical load. That is, with pattern A, tension and relaxation were synchronized between the load felt physically by the subjects and the sound that the subjects heard.

As the experimental results show, by using a sound control device according to this embodiment and by synchronizing the physical load that a user feels with tension and relaxation felt through listening to sound, it is possible to increase the concentration level of the user.

### Alternative Interface Portion Example

Note that the interface portion 15 is not limited to configurations like that of FIG. 4.

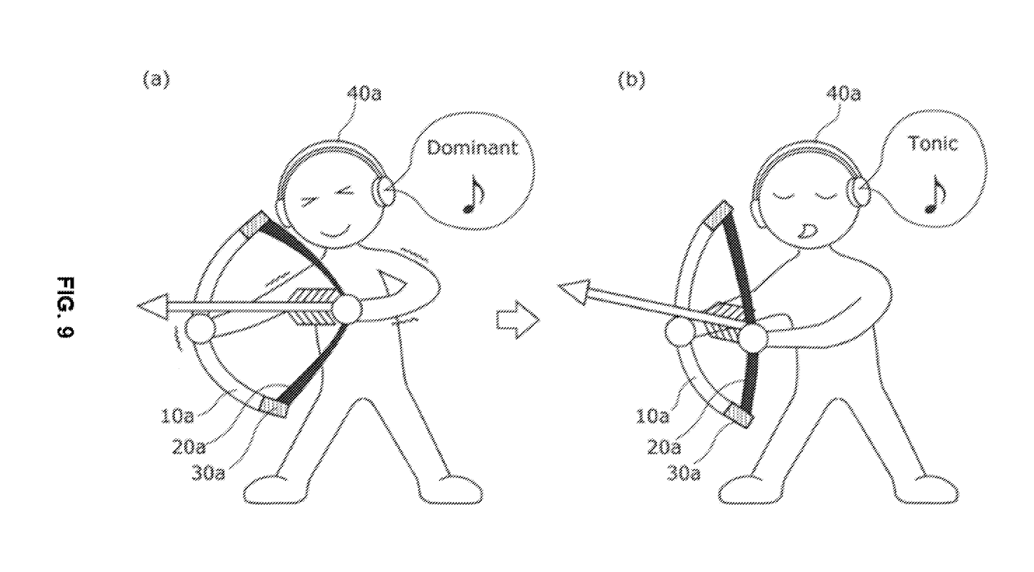

For example, as shown in FIG. 9, the interface portion may have a bow and arrow shape. The bow and arrow shape interface portion 15 shown in FIG. 9 includes a sensor 30a for detecting an elastic force on a string 20a that is an elastic member set at both ends of a bow 10a. Further, headphones 40a are used as speakers in the vicinity of the ears with the example of FIG. 9.

In this case a user may input load by pulling back on the string 20a of the bow 10a, as shown in FIG. 9a. For cases where the load input by the user is equal to or greater than the first threshold value, a dominant tone sound is output from the headphones 40a, as shown in FIG. 9a. When the load is decreased, however, and is less than the second threshold value, the headphones 40a output a tonic tone sound, as shown in FIG. 9b.

### Specific Sound Control Device Example

A specific application example of the sound control device 100 is explained next.

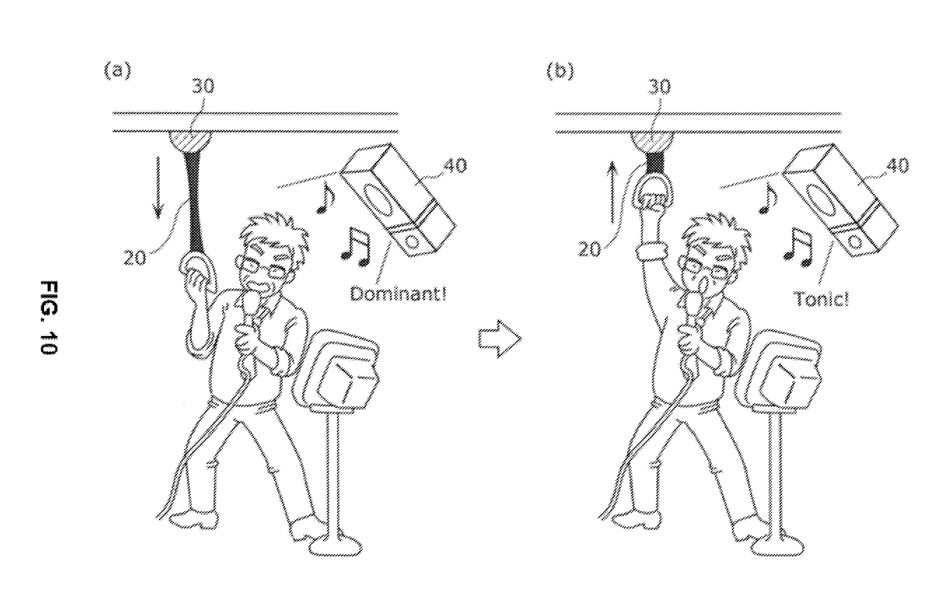

FIG. 10 is a diagram showing an example application of a sound control device. FIG. 10 is a diagram showing a case of applying the sound control device 100 to a karaoke device.

For example, when singing a song using a karaoke device, there may be a point where a user desires to slow down the rhythm (achieve a time extension). This rhythm slowing point often corresponds to a state of tension in the song when considering the spring-like qualities discussed above.

Therefore, a user can actively create a rhythm slowing point by using the sound control device 100.

Specifically, as shown in FIG. 10a, a user can apply a load to the sensor 30 provided on a ceiling by pulling back on the elastic member 20 at the point the user wants to slow the rhythm. At that point, the control portion 50 causes a final sound of a phrase output from the speaker to be output continuously (extended) if the load input is equal to or greater than the first threshold value.

After creating a desired rhythm reduction, the user can reduce the load added to the elastic member 20. The control portion 50 will output a phrase after the continuously output final sound if the load is less than the second threshold value.

By using the sound control device 100 in a karaoke device, a user can create a desired rhythm reduction and obtain a sense of well-being.

### Alternative Sound Control Device Example

The sound control device 100 according to embodiment 1 is explained above. However, embodiments of the sound control device 100 are not limited to embodiment 1.

For example, it is possible to realize the sound control device 100 according to this embodiment in a tablet-type terminal device or the like.

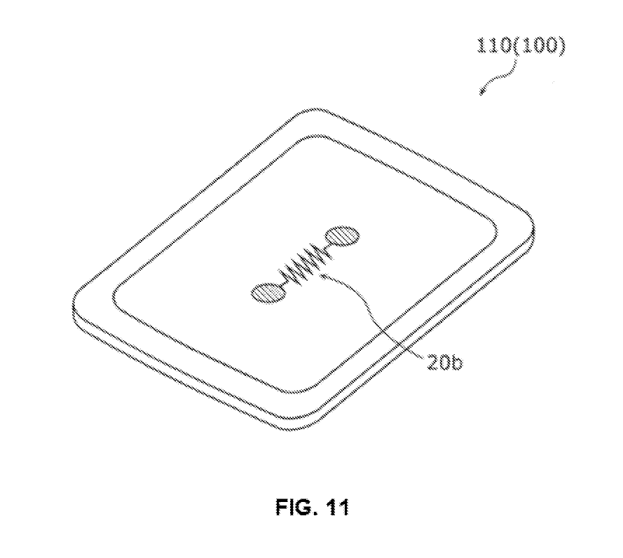

FIG. 11 is a diagram showing an example of applying a sound control device to a tablet-type terminal device.

The interface portion 15 in this case is made from a display screen of a tablet terminal 110, and an overlapping touch panel capable of receiving load inputs due to user touch operations.

Further, a virtual elastic member 20b created by the control portion 50 is shown in the display screen. The virtual elastic member 20b expands and contracts corresponding to operations of the user on the touch panel. Note that, although not shown in the figures, the speaker 40 is provided to the tablet-type terminal

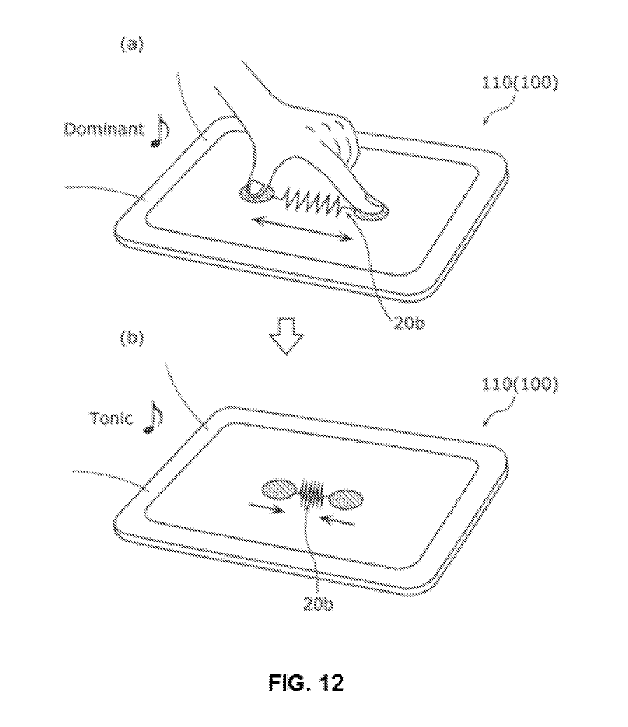

FIG. 12 is a diagram for explaining operation when applying a sound control device to a tablet-type terminal device.

As FIG. 12a shows, a user may add a virtual load to the virtual elastic member 20b against a restorative force of the virtual elastic member 20b. For example, as shown in FIG. 12a, the user may compress the virtual elastic member 20b against a portion corresponding to both ends of the elastic member 20b of the touch panel. That is, the control portion 50 displays a dynamic image on the display screen showing the elastic member 20b compressed according to a pinch-in operation by the user.

Note that the user may also extend the virtual elastic member 20b by performing a pinch-out operation with respect to a portion corresponding to both ends of the elastic member 20b of the touch panel.

In this case the elastic force of the virtual elastic member 20b is indicated by the amount of pinch-in operation of the user (movement amount by the user's finger on the touch panel. For cases where the pinch-in amount of the user is equal to or greater than the first threshold value, the control portion 50 outputs a dominant tone sound to the speaker 40 of the tablet-type terminal

As shown in FIG. 12b, when the user removes a finger from the touch panel, the virtual load imparted by the user to the elastic member 20b becomes zero. That is, the virtual load applied to the elastic member 20b by the user becomes less than the second threshold value.

At this point the virtual elastic member 20b returns to its original length due to a restorative force. That is, the control portion 50 outputs a display image of a dynamic image of the compressed elastic member 20b returning to its original length. The control portion 50 outputs a tonic tone sound to the speaker 40 of the tablet-type terminal device here.

For cases where the user increases the virtual load on the virtual elastic member 20b, the user feels the load visually according to the dynamic image of the elastic member 20b. That is, the load input means an input amount capable of causing the user to feel load using physical senses.

Therefore the image that the control portion 50 displays on the display screen is not limited to the virtual elastic member 20b (a spring). Images (or dynamic images) that cause the user to feel load may also be displayed.

For example, the control portion 50 may display a virtual round gumball on the display screen. In this case the virtual round gumball is displayed by a mode where it is pushed into the display screen, and contracts and expands according to virtual load inputs by the user to the touch panel.

Further, for cases where there is a virtual load (pinch-in or pinch-out operations) applied by the user to the touch panel, the control portion 50 may display a weight on the display screen, causing the user to perceive a weight according to the image of a weight. When the user reduces the virtual load input, the control panel may display an image of a “feather” on the display screen, causing the user to perceive a reduction in load.

Further, the image for causing the user to perceive load may be further simplified. For example, for cases where the user imparts a virtual load to the touch panel, the control portion 50 may change the color density of the image, causing the user to perceive load visually. Specifically, when the image color is orange, for example, the color of the image corresponding to an increased virtual load may be changed to an orange color having multiple red color components, causing the user to perceive the load.

Further, the control portion 50 may also cause the user to perceive load by changing the surface area of a graphically displayed shape (circle, triangle, rectangle, or the like) displayed as an image. Specifically, the surface area of the graphically displayed shape may be reduced, for example, when the user performs a pinch-in operation on the touch panel. The surface area of the graphically displayed shape may be increased for cases where the user performs a pinch-out operation.

It is thus possible for the sound control device 100 to cause a user to physically experience the spring-like qualities of music by coupling a load felt visually by a user to a sound felt through hearing.

### Embodiment 2

In Embodiment 1, an example of using an elastic portion or a virtual elastic portion in an interface portion was explained, but the interface portion is not limited to a configuration using an elastic member.

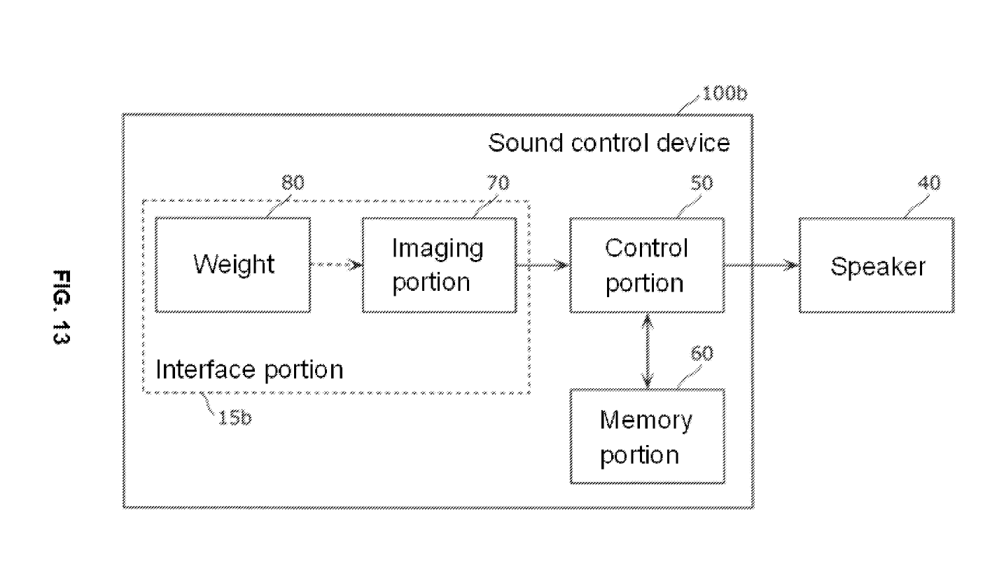

FIG. 13 is a block diagram indicating a sound control device system configuration according to the second embodiment.

As FIG. 13 shows, a sound control device 100b according to embodiment 2 includes an interface portion 15b, the control portion 50, and the memory portion 60. Further, the sound control device 100b is connected to the speaker 40.

The interface portion 15b according to embodiment 2 includes an imaging portion 70 and weights 80. The image portion 70 is a CMOS (Complementary Metal Oxide Semiconductor) camera, for example, but may also use a CCD (Charge Coupled Device).

Operation of the sound control device 100b is explained next.

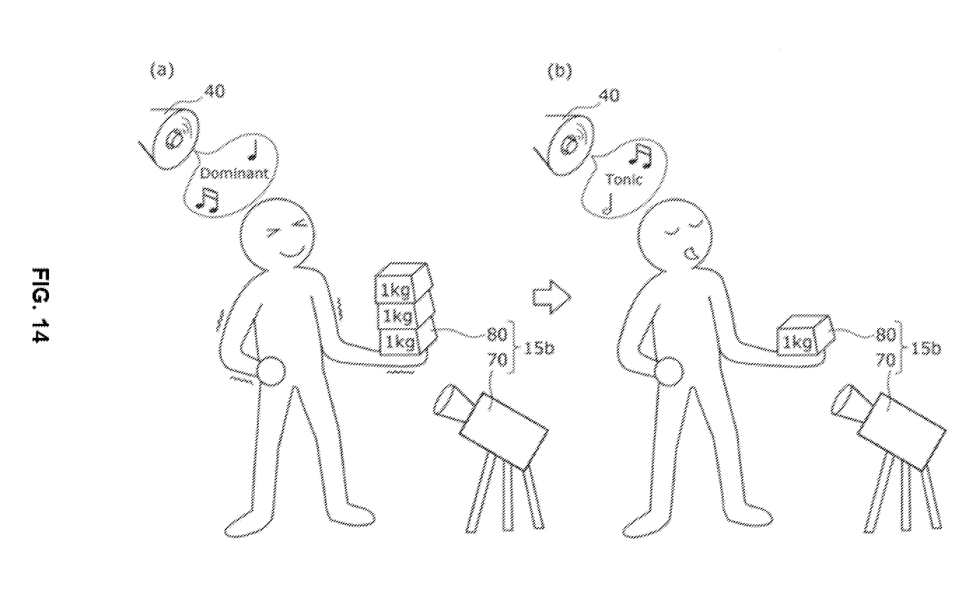

FIG. 14 is a diagram for explaining operation of a sound control device according to the second embodiment.

In embodiment 2, a user performs lifting operations on the weights 80. The interface portion 15b receives user load input (number of the weights 80) via the imaging portion 70 photographing the user as the user lifts up the weights 80.

The control portion 50 may detect that the user has lifted up either one or a plurality of substantially identically shaped weights, for example, within an image taken by the imaging portion 70. The control portion 50 may then output a sound to the speaker 40 based on a threshold value set according to the number of weight.

Specifically, by using a Laplacian filter, for example, the control portion 50 may detect large edge portions of the weights due to changes in the brightness level of image pixels. The control portion 50 can detect the number of weights that a user has lifted up by referencing shape data on the weights 80 stored in the memory portion 60 against edge portion shapes of the weights 80 within an image taken by the imaging portion 70

As FIG. 14a shows, the user may lift up a plurality of the weights 80. The control portion 50 detects the weights 80 from the image taken by the imaging portion 70. If the number of weights 80 is equal to or greater than the first threshold value, the control portion 50 outputs a dominant tone sound to the speaker 40.

Further, as FIG. 14b shows, if the user reduces the number of the weights 80 from that shown in FIG. 14a, and the number of the weights 80 lifted up is less than the second threshold value, then the control portion outputs a tonic tone sound to the speaker 40.

Note that threshold values may also be set, for example, according to a positional relationship between user and weight position. For example, thresholds may be set to reflect that the load input is smaller when the position of the weights is lower toward the ground with respect to the user's height, and that the load input is larger when the position of the weights is higher up away from the ground with respect to the user's height.

The interface portion 15b including the imaging portion 70 is explained above. Embodiments of the interface portion are not limited to those explained in embodiment 1 and embodiment 2, however. For example, the interface portion may also be a bicycle, a microphone, or a musical instrument (flute, keyboard, guitar, or the like).

For example, when the interface portion is a bicycle, a user may perform bicycle pedaling operations. The interface portion may be provided with a counter to count the number of wheel rotations, and thus detect load input by the number of wheel rotations per unit time. In this case the control portion may output a dominant tone sound or a tonic tone sound to a speaker based on a threshold value set for the number of wheel rotations per unit time.

Further, when using the interface portion in a microphone, for example, a user may perform operations by vocalizing toward the microphone. The interface portion may be provided with a volume measuring device, and thus detect load input based on the volume of the voice input to the microphone. In this case the control portion may output a dominant tone sound or a tonic tone sound to a speaker based on a threshold set based on voice volume.

When the interface portion is a musical instrument, for example a flute, the user may perform flute blowing operations. The interface portion may be provided with an air pressure gauge, and detect load input as air pressure as the user blows into the flute. In this case the control portion may output a dominant tone sound or a tonic tone sound to a speaker based on a threshold value set based on the air pressure from a user blowing into the flute.

As described in the example shown above, the interface portion may be configured to receive a physical amount of load input, indicating a load size perceived by the user, due to user operations.

### Additional Embodiment

Embodiment 1 and embodiment 2 are explained above, but the present invention is not limited to those embodiments.

For example, it is possible to use a sound control device according to this embodiment in an entrance gate to a museum, theme park, or the like.

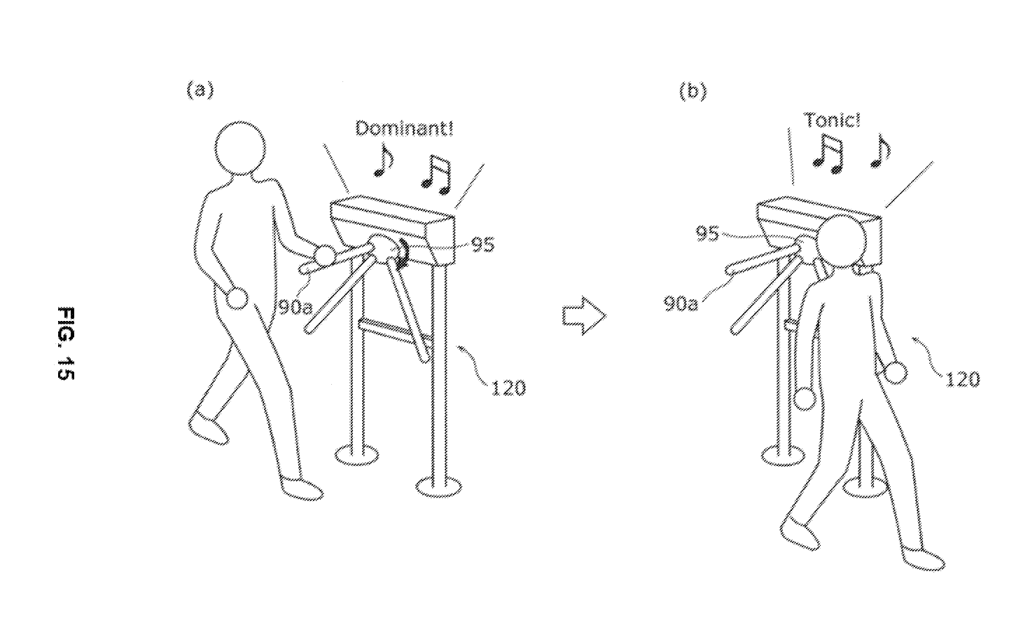

FIG. 15 is a diagram showing a case where a sound control device is applied to an entry gate.

With an entrance gate shown in FIG. 15, a rotational mechanism 95 only operates in one direction when a bar 90a is pushed by a user (the direction of an arrow in FIG. 15a). The user can thus pass through the entrance gate by pushing on the bar 90a, as FIG. 15b shows.

A rotational mechanism 95 rotates due to the user pushing on the bar 90a, and thus it is necessary for the user to apply a predefined load to push the bar 90a. That is, in a state where the user pushes on the bar 90a but the rotational mechanism 95 does not rotate, the load perceived by the user (the load indicated by a load input) may be said to be in a first state having a predefined size. FIG. 15a is a diagram indicating this state. At this point the control portion may output a dominant tone sound from a speaker of an entrance gate 120.

When the user increases the load and the rotational mechanism 95 begins to rotate, the load perceived by the user (load indicated by a load input) drops. This state may be said to be a second state where the load input sets a threshold value. FIG. 15b is a diagram indicating this state. At this point the control portion outputs a tonic tone sound to the speaker of the entrance gate 120.

By thus using a sound control device at a theme park or similar venue, entrants are able to physically feel the spring-like qualities of music at an entrance gate and have a feeling of well-being.

Further, a sound control device according to this embodiment can also be used in a ticket gate for public transportation, such as a train.

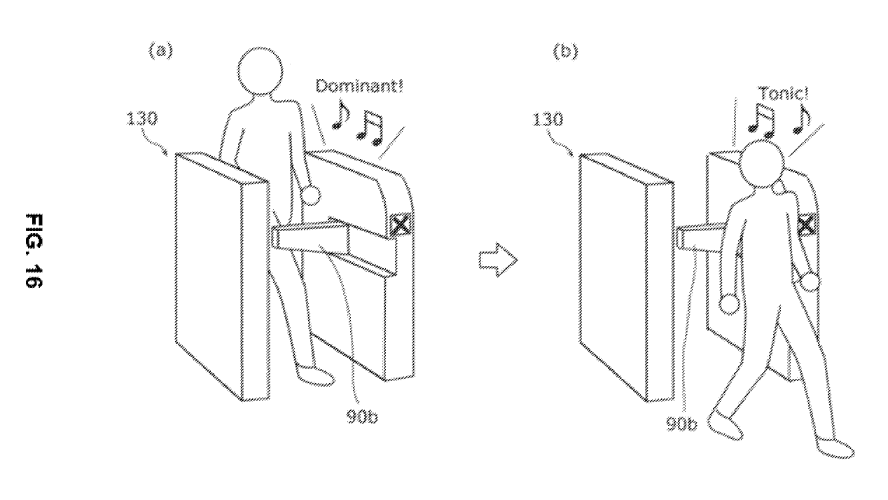

FIG. 16 is a diagram showing a case where a sound control device is applied to an automatic turnstile.

A ticket gate 130 is normally provided with a gate capable of opening and closing (not shown in the figure) when a user places a ticket in the ticket gate 130 or swipes a non-touch IC card over the ticket gate 130. In addition to this type of ticket gate, one provided with an elastic bar 90b to prevent the user from passing through, and where the user must physically touch the ticket gate 130, may also be used.

It is possible for the user to pass through the ticket gate 130 by pushing on the bar 90b. However, at this point it is necessary for the user to apply a predefined minimal load to the bar 90b. In a state where the user is pushing on the bar 90b with the predefined load, the load perceived by the user (the load indicated by a load input) may be said to be in a first state having a predefined load size. FIG. 16a is a diagram indicating this state. At this point the control portion may output a dominant tone sound to a speaker of the ticket gate 130.

After the user passes through the ticket gate 130, the bar 90b is in a state having no applied load. This state may be said to be a second state where the load perceived by the user is reduced. FIG. 16b is a diagram indicating this state. At this point the control portion may output a tonic tone sound from the speaker of the ticket gate 130.

Note that when it is possible for the user to pass through the ticket gate 130 by using a portable terminal, such as a mobile phone or the like, the user may be made to perceive the load by using a function of the portable terminal, such as a vibration function.

Further, it is also possible to apply the sound control device according to this embodiment to a sports training apparatus or the like. For example, it is possible to apply the sound control device of this embodiment to a batting practice apparatus.

Specifically, in a batting practice apparatus, a predefined load is set to be applied to a hitter's body when in a state waiting for a ball. A rubber tube or the like may be connected to a bat, for example. This state may be taken as a first state. A dominant tone sound may therefore be output from a speaker at this time.

Further, with the batting practice apparatus, a state where the batter has swung a bat and the bat has traveled to a contact point, which is an ideal position for a batter to hit a ball, is taken as a second state. At the same time as a load applied to the batter's body is reduced, a tonic tone sound is output from a speaker. The batter can thus physically perceive the contact point.

Effective practice can thus be carried out through body control while feeling sound through listening.

Further, a sound control device according to this embodiment can also be applied to a vehicle.

During operation of a vehicle, a user (driver) presses down on an accelerator, and reception of a predefined load input (amount that the accelerator is pressed down) from the user may be said to be a first state. A state where the user relaxes pressure on the accelerator is a second state.

In the first state, a dominant tone sound may be output, and in the second state a tonic tone sound may be output. The user thus continues to hear a dominant tone sound when continuing to increase speed, but hears a tonic tone sound when reducing pressure on the accelerator and reducing speed. In other words, the sound control device of this embodiment can be effective in preventing excessive vehicle speed caused by the user.

Note that in the embodiments described above, all constitutive elements may be configured using specialized hardware. The constitutive elements may also be configured by running suitable software programs. Each of the constitutive elements can be configured by using a program execution portion, such as a CPU or other processor, to read out and then execute a software program stored on a hard disk, semiconductor memory, or other recording medium. Software for implementing a simulation device of this embodiment may be configured by the following or similar program.

A program may be executed using a computer to implement a method of controlling sound to output a sound to a speaker using an interface portion for receiving a load input, recognized by a user, according to an operation by the user, including: outputting a dominant tone sound to the speaker in a first state where the size of the load displayed according to the load input is greater than a predefined size; and outputting a tonic tone sound to the speaker in a second state where the size of the load displayed according to the load input is less than the predefined size from the first state.

Further, cases like those described below are included within the scope of the present invention.

(1) The devices described above may specifically be made using a computer system configured by a microprocessor, a ROM, a RAM, a hard disk unit, a display unit, a keyboard, a mouse, or the like. A computer program may be stored in the RAM or in the hard disk unit. The microprocessor may operate in accordance with instructions from a computer program, thus configuring other devices. The term computer program as used here means a plurality of groups of instruction code indicating commands for the computer in order to achieve predefined functions.

(2) All, or a portion of, the constitutive elements of each of the devices described above may be configured using a single system LSI (Large Scale Integration). System LSI means a super multifunctional LSI manufactured by integrating a plurality of configuration portions on one chip. Specifically, LSI means a computer system configured including a microprocessor, ROM, RAM, and the like. A computer program is stored in a ROM. A microprocessor loads the computer program from the ROM into a RAM. The system LSI achieves its functionality by running computations and the like in accordance with the computer program loaded into the RAM.

(3) All, or a portion of, the constitutive elements of each of the devices described above may be configured from a mountable and demountable IC card or from a single module. IC cards and modules are computer systems configured from a microprocessor a ROM, a RAM, and the like. An IC card or a module may also include a super multi-functional LSI as described above. A microprocessor may achieve the functionality of an IC card or module by operations performed in accordance with a computer program. The IC card or module may also have anti-tampering functionality.

(4) The present invention may also be made using the methods described above. Further, the methods described above may be realized by using a computer program run by a computer, and by a digital signal from a computer program.

Furthermore, the present invention may be made from a computer program or a digital signal stored in a computer readable storage medium, such as a hard disk, a CD-ROM, an MO, a DVD, a DVD-ROM, a DVD-RAM, a Blue-ray Disc (BD), a semiconductor memory, or the like. Further, the present invention can be realized by a digital signal stored in one of the described recording mediums.

Furthermore, a computer program or a digital signal of this invention may be transmitted via an electrical communication line, a wireless or wired communication line, a network such the Internet, a data broadcast, or the like.

Further, the present invention may be a computer system including a microprocessor and a memory. The memory may store a computer program, and the microprocessor may operate in accordance with the computer program.

Further, the present invention may be made from a separate, independent computer system where a program or a digital signal is stored in a recording medium and transferred, or where a program or digital signal is transferred via a digital network.

(5) Each of the embodiments and variations may also be combined together.

Note that the present invention is not limited to the described embodiments or variations. Without departing from the spirit of the present invention, all embodiments and variations and combinations thereof that may occur to one skilled in the art also fall within the scope of the present invention

### INDUSTRIAL APPLICABILITY

It is possible to apply the present invention to a karaoke device or a tablet terminal as a sound control device that allows a user to physically experience the spring-like qualities of music.

### EXPLANATION OF REFERENCE SYMBOLS

10 Support member
10a Bow
15, 15b Interface portion
20, 20b Elastic member
20a String
30, 30a Sensor
40, 150a, 150b, 150c Speaker
40a Headphone
50 Control portion
60 Memory portion
70 Imaging portion
80 Weight
90a, 90b Bar
95 Rotational mechanism
100, 100b Sound control device
110 Tablet device
120 Entrance gate
130 Ticket gate
140a Start point
140b Tunnel
140c End point

I/we claim:

1. A sound control device comprising:
an interface portion for receiving a load input indicating a load size perceived by a user due to user operation; and
a control portion for outputting a sound to a speaker corresponding to the load input received by the interface portion;
wherein the control portion outputs a dominant tone sound to the speaker in a first state where the size of the load indicated by the load input is larger than a predefined size; and
wherein the control portion outputs a tonic tone sound to the speaker in a second state where the size of the load indicated by the load input has decreased to less than the predefined size of the first state.

2. The sound control device according to claim 1, wherein the control portion:
outputs a dominant chord sound, a sub-dominant chord sound, or a sub-dominant minor chord sound to the speaker as the dominant tone sound in the first state; and
outputs a tonic chord sound to the speaker as the tonic tone sound in the second state.

3. The sound control device according to claim 1, wherein the control portion:
outputs a first song to the speaker as the dominant tone sound in the first state; and
outputs a second song to the speaker as the tonic tone sound in the second state, the second song imparting less of a sense of tension to the user than the first song.

4. The sound control device according to claim 1, wherein the control portion:
outputs a leading note to the speaker as the dominant tone in the first state; and
outputs a tonic tone to the speaker as the tonic tone to the speaker in the second state.

5. The sound control device according to claim 1, wherein the control portion:
outputs a predefined song to the speaker;
outputs a bar portion of a dominant chord, or a sub-dominant chord, of the predefined song to the speaker as the dominant tone sound in the first state; and
outputs a bar portion of a tonic chord of the predefined song to the speaker as the tonic tone sound in the second state.

6. The sound control device according to claim 1, wherein the control portion:
outputs a first acoustic pressure level dominant tone sound to the speaker in the first state; and
outputs a second acoustic pressure level tonic tone sound to the speaker in the second state, the second acoustic pressure level being less than the first acoustic pressure level.

7. The sound control device according to claim 1, wherein the control portion:
outputs a first tempo dominant tone sound to the speaker in the first state; and
outputs a second tempo tonic tone sound to the speaker in the second state, the second tempo being slower than the first tempo.

8. The sound control device according to claim 1, wherein:
from a state where the control portion outputs a tonic tone sound to the speaker, the control portion then outputs a dominant tone sound to the speaker in the first state when the size of the load indicated by the load input becomes larger than a predefined size.

9. The sound control device according to claim 1, wherein:
the interface portion comprises:
an elastic member that expands and contracts according to the user operation; and
a detection portion that detects an elastic force on the elastic member due to the user operation as the load input; and
the first state is a state where the elastic force on the elastic member detected by the detection portion due to the user operation is equal to or greater than a first threshold value; and
the second state is a state where the elastic force on the elastic member detected by the detection portion due to the user operation is less than a second threshold value.

10. The sound control device according to claim 1, wherein:
the interface portion comprises:
a display screen; and
a touch panel overlaying the display screen for receiving the load input of the user due to a touch action of the user;
the control portion displays a virtual elastic member on the display, the virtual elastic member allowing the user to recognize a load due to expansion and contraction caused by the touch operation of the user;
the first state is a state where the size of the load displayed according to an expansion or contraction amount of the virtual expansion member is a predefined size; and
the second state is a state where the size of the load displayed according to the amount of expansion or contraction of the virtual elastic member is less than the predefined size.

11. A method of controlling sound to output a sound to a speaker using an interface portion for receiving a load input, recognized by a user, according to an operation by the user, comprising:
outputting a dominant tone sound to the speaker in a first state where the size of the load displayed according to the load input is larger than a predefined size; and
outputting a tonic tone sound to the speaker in a second state where the size of the load displayed according to the load input is less than the predefined size of the first state.

12. A program for implementing the method of claim 11 in a computer.

13. A sound control device comprising:
an interface portion for receiving a load input indicating a load size perceived by a user due to user operation; and
a control portion for outputting a sound to a speaker corresponding to the load input received by the interface portion;
wherein the control portion outputs a first sound to the speaker in a first state where the size of the load indicated by the load input is larger than a predefined size; and
wherein the control portion outputs a second sound to the speaker in a second state where the size of the load indicated by the load input has decreased to less than the predefined size of the first state, the second sound imparting less of a sense of tension to the user than the first sound.

14. A sound control device comprising:
an interface portion for receiving a load input indicating a load size perceived by a user due to user operation; and
a control portion for outputting a sound to a speaker corresponding to the load input received by the interface portion;
wherein the control portion outputs a first sound to the speaker in a first state where the size of the load indicated by the load input is larger than a predefined size; and
wherein the control portion outputs a second sound to the speaker in a second state where the size of the load indicated by the load input has decreased to less than the predefined size of the first state, the second sound causes the user to relax more than the first sound.
